(19) United States
(12) Patent Application Publication
(10) Pub. No.: US 2017/0006686 A1
(43) Pub. Date: Jan. 5, 2017

(54) METHOD FOR CONTROLLING AN ADAPTIVE ILLUMINATION DEVICE, AND AN ILLUMINATION SYSTEM FOR CARRYING OUT SAID METHOD

(71) Applicant: ZUMTOBEL LIGHTING GMBH, Dornbirn (AT)

(72) Inventor: Klaus VAMBERSZKY, Bregenz (AT)

(21) Appl. No.: 15/113,231

(22) PCT Filed: Jan. 20, 2015
(86) PCT No.: PCT/EP2015/050973

§ 371 Date: Jul. 21, 2016

(30) Foreign Application Priority Data
Jan. 22, 2014 (DE) 10 2014 201 144.2

(51) Int. Cl. H05B 33/08; H04N 9/04; G06T 7/40; H05B 37/02; G06K 9/46

(52) U.S. Cl. CPC H05B 33/0872; H05B 37/0227; H05B 33/0854; H05B 37/0272; G06K 9/4652; G06T 7/408; H04N 9/045

(57) ABSTRACT

A method for controlling an adaptive illumination device, for illuminating a product presentation surface, by providing an adaptive illumination device which has: at least one light-emitting diode module configured to emit light of a specific spectrum; a control unit for controlling the light emission of the light-emitting diode module; and an interface for wireless communication; providing a mobile terminal that includes an interface for wireless communication and at least one digital camera unit; providing a digital image of the surface to be illuminated by the adaptive illumination device and/or of an object to be illuminated, using the camera unit of the mobile terminal; analyzing the digital image and determining at least one color that is dominant; actuating the light-emitting diode module using the control unit such that it emits light of a specific spectrum as a function of the color in the digital image determined to be dominant.

### 1. FIELD OF THE INVENTION

The present invention relates to a method for controlling an adaptive illumination apparatus, particularly for illuminating a goods presentation area, and to an illumination system for performing such a method.

### 2. BACKGROUND

In department stores and shops, particularly in grocery shops, a white illumination, for example with a relatively high proportion of red, green and/or yellow light, is frequently used in order to thereby improve the presentation of goods, for example of reddish, greenish or yellowish goods (such as particularly meat, vegetables or cheese). This frequently involves a dominant color or a dominant color component of the goods presentation area to be illuminated or of the goods to be illuminated (for example red for meat products, for example green for vegetable products, and yellow for cheese and bread products) being intensified so as thereby to convey a particularly positive color impression for the displayed goods to the consumer.

This involves the use of illuminations or illuminants that can mix a specific peak or secondary peak (particularly in the red, green or yellow color range) into the emitted light depending on the illumination situation. Such an illuminant is disclosed in the document DE 20 2008 005 509 U1 in the prior art in the form of a light emitting diode module, for example. Such a light emitting diode module is preferably used in the present method according to the invention or in an illumination system according to the invention.

A light emitting diode module of this kind allows the user to manually adjust the emitted light to the respective specific illumination situation. This requires the user to independently assess what specific illumination (particularly what color peaks or secondary color peaks) fits the area to be illuminated or the products to be illuminated. One problem in this case is that adjustment of the illumination is based exclusively on the subjective color or illumination perception of a user.

Illuminations have therefore been developed in the prior art that comprise an implemented sensor system that is used to effect the specific illumination to the respective area to be illuminated automatically so as thus to be able to perform adjustment of the illumination independently of the subjective perception of a user. Such an illumination having an implemented sensor system is disclosed in the document EP 2 541 362 A1, for example. In this case, the sensor system implemented in the illumination captures at least one dominant color of the area to be illuminated or of the product to be illuminated and automatically performs appropriate control of the illumination.

Although this solution is independent of the subjective color or illumination perception of a user, such a solution is also relatively costly, since an appropriate sensor system needs to be provided in each illumination. Furthermore, the sensor system needs to be regularly or continuously calibrated in order to be able to ensure optimum control of the illumination. Finally, it has also been found in practice that the sensor system has a comparatively high susceptibility to interference or failure, which can be attributed to its relatively high thermal loading within the illumination.

Against the background of this prior art, the present invention is faced with the problem of specifying a method for controlling an adaptive illumination apparatus in which the aforementioned disadvantages of the prior art are overcome or alleviated.

In particular, the present invention is faced with the problem of providing a method that can be used to match an adaptive illumination apparatus (which preferably comprises a light emitting diode module disclosed in the document DE 20 2008 005 509 U1) to an area to be illuminated or to a product to be illuminated as simply as possible without at that time being reliant on the subjective color perception of a user and without having to provide a complex and hence expensive sensor system in an illumination apparatus. Furthermore, the aim is to specify an illumination system that can be used to perform the method according to the invention.

These and other problems that will be cited on reading the following description or can be identified by a person skilled in the art are solved by the subject matter of the independent claims. The dependent claims develop the central concept of the invention in a particularly advantageous manner.

### 3. DETAILED DESCRIPTION OF THE INVENTION

The method according to the invention for controlling an adaptive illumination apparatus, particularly for illuminating a goods presentation area, comprises the following steps in this case:
provision of an adaptive illuminating apparatus, comprising: at least one light emitting diode module (LED module) that is set up to emit light having a specific spectrum; a control unit for controlling the light emission of the LED module; and an interface for wireless communication;
provision of a mobile terminal, comprising an interface for wireless communication and at least one digital camera unit;
provision of a digital depiction of the area to be illuminated by the adaptive illumination apparatus and/or of an object to be illuminated by the adaptive illumination apparatus using the camera unit of the mobile terminal;
performance of an analysis of the digital depiction and ascertainment of at least one color that is dominant in the digital depiction;
actuation of the LED module by the control unit such that the latter takes the ascertained dominant color of the digital depiction as a basis for emitting light having a specific spectrum.

The method according to the invention thus proposes, instead of the aforementioned relatively expensive and complex sensor system that needs to be associated with a respective illumination unit, using a mobile terminal (for example a digital camera or a smartphone) to produce a digital depiction of the area to be illuminated and analyzing this digital depiction and ascertaining at least one dominant color component of the digital depiction.

In other words, the method according to the invention proposes replacing the sensor system disclosed in the prior art with a digital camera of a mobile terminal, the latter being able to be used for all illumination apparatuses to be adjusted or actuated that are arranged in a department store, for example.

In this case, an active illumination apparatus according to the invention is intended to be understood to mean any (spectrally) adjustable or actuable illuminant module—particularly an LED module—that can emit a specific light spectrum (e.g. in order thereby to be able to mix one or more specific (selected) (color) peaks or secondary (color) peaks into a white light or to be able to mix a specific color component into the white light, in order thereby to be able to provide a matching (continuous) spectrum, for example). As already stated above, performance of the method according to the invention preferably involves the use of an LED module that is disclosed in the document DE 20 2008 005 509 U1. In principle, however, other (spectrally) adjustable or actuable illuminants (illuminant modules) are also conceivable that satisfy the aforementioned properties. For the sake of simplicity, the text below refers to “LED module” or “light emitting diode module”, other illuminants accordingly also being covered by the invention in principle.

In this case, a control unit according to the invention for an adaptive illumination apparatus is intended to be understood to mean any unit that is suitable for processing control commands (which are transmitted by the mobile terminal, for example) for the adaptive illumination apparatus for controlling the light emission of the LED module or that can take the analysis data from the digital depiction (which are transmitted by the mobile terminal, for example) as a basis for performing appropriate control of the LED module.

In this case, the digital depiction can be produced for the whole area to be illuminated or just for one product unit that needs to be displayed on the area to be illuminated. By way of example, a digital depiction can be produced for the whole display (e.g. a vegetable, meat, cheese or bread display) or just for one product that is representative of the display.

In the present case, the term dominant color can be understood to mean an exact color (location) point (for example specified by a light wavelength) or a wider or less wide color (location) range or spectral range (for example specified by a light wavelength range). In other words, the term dominant color is not intended to be understood in a restrictive manner as a punctiform color value/location.

Usually, the dominant color of meat products is red, of bread and cheese products is yellow and of vegetable products is green. Preferably, these products are lit with a light that corresponds to the ascertained dominant color (i.e. for example a meat display is illuminated with a (white) light having an increased red component, a bread or cheese display is illuminated with an increased yellow component and a vegetable display is illuminated with an increased green component).

However, there may be illumination situations in which it is desirable to mix into the light emitted by the LED module a color component (e.g. a peak or a secondary peak) that does not correspond to the ascertained dominant color. This may be the case with illumination of textile displays, exhibits in museums/galleries, in conference halls or work places, for example. Besides color mixtures in the red, yellow and/or green color range, color mixtures in all other conceivable (visible) colors or color ranges are therefore also additionally or alternatively conceivable.

A method according to the invention, particularly incorporation of a mobile terminal that is available in most cases anyway, for capturing a digital depiction of an area to be illuminated or of an object to be illuminated therefore provides the option of dispensing with additional sensor systems or capture devices particularly in the luminaire itself, and hence of being able to provide much simpler, less costly and more reliable actuation of an adaptive illumination apparatus.

Advantageously, the mobile terminal is a digital camera or a smartphone having at least one digital camera that are able to be used to provide a digital depiction in raw data format (“raw data”), in JPEG format (“File Interchange Format”) or in TIFF format (“Tagged Image File Format”).

The use of already available mobile terminals, such as a digital camera or smartphone, for example, has the advantage that the result is scalable; e.g. high end with a good digital camera and high resolution photographs or low end with a smartphone and lower resolution photographs.

In this case, provision of the digital depiction in raw data format has the advantage that analysis of these data does not involve a risk of color losses or errors through compression of the data. Insofar as compression of the raw data is desired or necessary, it has been found in practice that provision of the digital depiction in JPEG format or in TIFF format allows an analysis of the digital depiction to be performed with a sufficient high and reproducible quality.

Advantageously, analysis of the digital depiction furthermore also involves the brightness, the size of the area to be illuminated or the surface condition of the area to be illuminated or of the product to be illuminated (for example whether said area is in reflective or absorbent form) being analyzed. Advantageously, actuation of the LED module is not only effected in terms of the color of the emitted light for an LED module but also comprises adjustment of the light emission angle, the light brightness, the light intensity and/or the light distribution. The incorporation of these further parameters firstly for the analysis of the digital depicting and secondly for the actuation of the LED module provides the option of analyzing an area to be illuminated relatively accurately and of being able to perform individual adjustment of the LED module, i.e. adjustment that accurately matches the respective illumination situation.

In a first preferred embodiment, the digital depiction is transmitted wirelessly from the mobile terminal to the adaptive illumination apparatus, with the transmitted digital depiction being analyzed by a data processing program of an image analysis unit of the adaptive illumination apparatus.

Preferably, the data processing program of the image analysis unit is in the form of an embedded data processing program (what is known as “embedded software”) in this case.

The image analysis unit, comprising an appropriate data processing program for analyzing a digital depiction, can be provided in the adaptive illumination apparatus at the factory itself in this case.

Such a refinement provides the option of a user producing digital depictions of the area to be illuminated or of the object to be illuminated by means of a commercially available mobile terminal (particularly by means of a digital camera or a smartphone) and wirelessly transmitting said digital depictions to the adaptive illumination apparatus, this requiring no specific matching and no specific data processing program to be provided on the mobile terminal. In other words, this embodiment has the option of performing a method according to the invention by means of commercially available mobile terminals, particularly without the need for specific hardware or software to be provided in the mobile terminal. For simplified operation, there may at the outside be provision for an appropriate App to be provided on the mobile terminal. This applies to all conceivable embodiments of the present invention.

In a second preferred embodiment of the present invention, the digital depiction is analyzed by a data processing program that is stored on the mobile terminal, wherein the mobile terminal transmits control data (i.e. either direct control commands for controlling the light emission of the LED module or appropriate image analysis data with the control unit can provide the actuating parameters or direct control commands for the LED module) to the control unit of the adaptive illumination apparatus for the purpose of actuating the light emitting diode module.

In contrast to the first embodiment, the analysis of the digital depiction in the second embodiment is effected in the mobile terminal, which, for this purpose, has or has stored an appropriate data processing program (for example an application software in the form of what is known as an App).

Such a refinement has the advantage that the data processing program for analyzing the digital depiction are able to be loaded or updated via the already available mobile radio interfaces of the smartphone. In other words, this provides the option of equipping users with an appropriate data processing program in a simple manner and of being able to update or service such a data processing program on a regular basis.

In a third preferred embodiment of the present invention, the mobile terminal transmits the digital depiction to a central computer unit, wherein the digital depiction is analyzed by a data processing program that is stored on the central computer unit.

Such a refinement again has the advantage that no specific hardware or software needs to be provided on the mobile terminal and the digital depiction can be transmitted to a central computer unit via an existing mobile radio network. In this case, the central computer unit can transmit the control data directly to the control unit of the adaptive illumination apparatus for the purpose of actuating the light emitting diode module if appropriate interfaces are available on the adaptive illumination apparatus. Alternatively, the central computer unit can first transmit the control data to the mobile terminal, which subsequently transmits the control data to the control unit of the adaptive illumination apparatus for the purpose of actuating the light emitting diode module.

Preferably, the light emitting diode module is actuated by resorting to a database stored in the mobile terminal, the illumination unit or the central computer unit, which database stores predefined illumination patterns or control commands for the purpose of actuating the light emitting diode module, wherein the database is taken as a basis for associating the predefined illumination patterns or control commands with the analyzed and/or ascertained data, and the light emitting diode module is actuated on the basis of this association. This allows predefined control commands or illumination patterns to be held for an actuation, which is able to be determined in a simple manner on the basis of the actually ascertained analysis data (for example dominant color). This makes it possible to dispense with complex computation operations, and the actuation is performed reliably and quickly.

Preferably, the wireless communication between the mobile terminal and the adaptive illumination apparatus is effected via a wireless local communication network, particularly a Wi-Fi network or a WLAN. Alternatively, the wireless communication between the mobile terminal and the adaptive illumination apparatus can also be effected by means of an RF/DC transmission, a Bluetooth transmission or a ZigBee transmission.

The invention further relates to an illumination system for performing a method according to the invention, wherein the illumination system comprises at least the following:
an adaptive illumination apparatus according to the invention, having at least one LED module that is set up to emit light having a specific spectrum; a control unit for controlling the light emission of the LED module; and an interface for wireless communication;
a mobile terminal, comprising an interface for wireless communication and furthermore having at least one digital camera unit for capturing a digital depiction of the area to be illuminated by the adaptive illumination apparatus and/or of an object to be illuminated by the adaptive illumination apparatus;
an analysis unit suitable for performing an analysis of the digital depiction, wherein at least one dominant color of the digital depiction is ascertained, and wherein the LED module is controllable on the basis of the ascertained dominant color of the digital depiction.

### 4. DESCRIPTION OF A PREFERRED EMBODIMENT

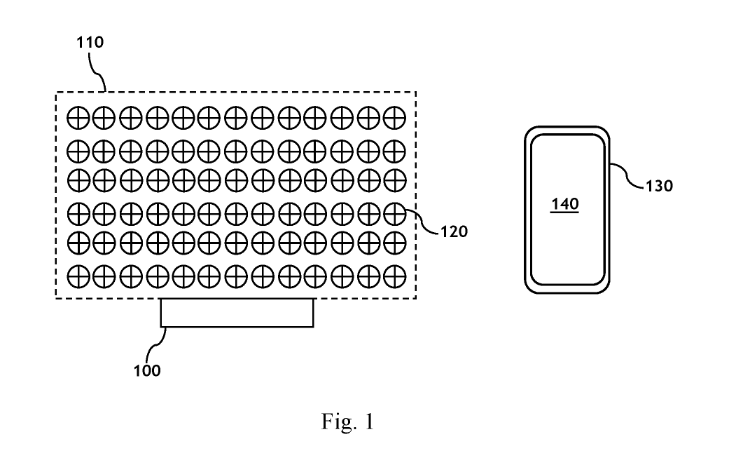

The text below provides a detailed description of the single FIG. 1, which shows a schematic view of an illumination system according to the invention.

FIG. 1 shows a schematic view of an illumination system according to the invention, comprising an adaptive illumination apparatus 100 that is designed to illuminate a goods presentation area 110 on which goods 120 are arranged. Further, the illumination system according to the invention comprises a mobile terminal, in the present case in the form of a smartphone 130.

In this case, the smartphone 130 comprises a data processing program (preferably what is known as a piece of application software in the form of an “App”) that has been transmitted to the smartphone 130 via an existing mobile radio network, for example, and has been stored on said smartphone.

To control or adjust the light emitted by the adaptive illumination apparatus 100, the user first produces a digital depiction (digital photo) of the goods presentation area 110 to be illuminated.

Alternatively, there is also the option of the user producing a digital depiction of a good 120 that is a color representation of the goods presentation area no. In addition, there is the option of the user not just producing one digital depiction of the goods presentation area 110 or of the good 120 but rather producing multiple digital depictions on which a subsequent image analysis can be based.

In this case, the digital depiction is preferably provided in JPEG format. Alternatively, however, it is also possible to use the image raw data (“raw data”) or a TIF format (“Tagged Image File Format”) or other digital image formats.

Production of a digital depiction of the goods presentation area 110 or of the good 120 is followed by an analysis (image analysis) of the digital depiction by means of the data processing program that is stored on the smartphone 130. In this case, at least one dominant color of the digital depiction is ascertained (e.g.

yellow is usually ascertained as the dominant color for a cheese display, red is usually ascertained for a meat display and green is usually ascertained for a vegetable display). By way of example, the dominant color can also be stipulated (manually) by identification/selection of a color area or of a product, for example on a sensitive display/user interface (e.g. a Touchscreen) 140 of the mobile terminal 130.

Preferably, analysis of the digital depiction also involves further parameters, such as brightness, the size of the goods presentation area no to be illuminated or of the good 120 and the surface condition (for example reflections, surface structure, etc.) of the goods presentation area no to be illuminated or of the good 120, for example, being.

Alternatively, there is also the option of the digital depiction being transmitted directly to the adaptive illumination unit 100 or to a central computer unit or control unit (not shown), so that in this case, the digital depiction is analyzed either in the adaptive illumination apparatus 100 or in the central computer unit by means of a data processing program that is available therein in each case. The central control or computer unit may be connected to the illumination unit wirelessly (for example via WLAN) or by wire (for example via DALI).

The analysis involves data (color location, brightness, size of the object, surface type and structure (for example specular or otherwise), etc.) obtained from the situation (for example fruit basket, meat counter, conference table, etc.) to be illuminated that is recorded by means of the digital camera unit being determined from the digital photograph. Following analysis of the digital depiction and ascertainment of a color that is dominant in the goods presentation area no or on the good, the smartphone 130 transmits appropriate control commands to the control unit of the adaptive illumination apparatus 100 by means of appropriate interfaces for wireless communication.

Preferably, a wireless communication between the smartphone 130 and the adaptive illumination apparatus 100 is effected via a wireless local communication network, particularly a Wi-Fi network or a WLAN, with, alternatively, an RF/DC transmission, a Bluetooth transmission or a ZigBee transmission also being able to be effected.

The data that are transmitted to the adaptive illumination apparatus 100 in this case may at that time already directly be control commands for the adaptive illumination apparatus 100 or merely analysis data that the control unit of the adaptive illumination apparatus 100 can use to adjust the light emission as appropriate.

Transmission of the relevant control data by the smartphone 130 to the adaptive illumination apparatus 100 is followed by appropriate control of the emitted light on the basis of the ascertained dominant color of the digital depiction. If it has been ascertained that the dominant color of the goods presentation area no is yellow (for example for bread or cheese), for example, then a yellow component can be mixed into the light emitted by the adaptive illumination apparatus 100, for example, in order to improve the subjective color impression of these goods for an observer. Preferably, image analysis likewise involves ascertainment of the light emission angle, light brightness and/or light distribution in which light needs to be emitted by the adaptive illumination apparatus 100 in order to allow optimum goods presentation.

In order to allow simple actuation of the light emitting diode module from the ascertained data, it is possible—on the basis of the analyzed or ascertained data (that is to say the dominant color or further data, for example)—to resort to a database having predefined illumination patterns or control commands, wherein predefined (groups of) analysis data to be ascertained have particular associated illumination patterns or control commands. As such, this database may store appropriate color spectra or other settings of the illumination unit 100 for respective instances of corresponding predefined ranges of particular data (for example captured color locations) as illumination patterns or control commands.

The illumination unit 100 or the LED module is then actuated by means of the illumination patterns or control commands from the database that are associated with the ascertained/analyzed data. In this case, the database may be stored in the mobile terminal 130, the illumination unit 100 or in a central computer unit.

As is evident to a person skilled in the art, the method according to the invention therefore provides the option of using a single “sensor system” in the form of a mobile terminal (preferably a smartphone or an appropriately equipped digital camera) for controlling/adjusting a multiplicity of adaptive illumination apparatuses arranged in a department store.

In comparison with the prior art, there is therefore a significant cost advantage, since the prior art to date has required an appropriate sensor system to be associated with each respective adaptive illumination means. Furthermore, the method according to the invention provides the option of using essentially any commercially available smartphone onto which an appropriate data processing program can be loaded for the purpose of performing a method according to the invention.

It should be pointed out that the present invention is not limited to a method and an illumination system for illuminating a goods presentation area, but rather can also be used in museums, in conference halls, at workplaces, in public spaces, on frontages, for street lighting and the like.

The actuation of the adaptive illumination apparatus is also not limited to intensifying an ascertained dominant color of the area to be illuminated or of the product to be illuminated such that a light component in the range of the dominant color is mixed into the emitted light or the light is emitted in the dominant color or in the (spectral) range (specific spectrum) of the dominant color, but rather it may also be desired for a color component or a color to be provided or to be adjusted that does not correspond to the dominant color. Furthermore, the light component that can be mixed into the emitted (white) light, or the specific spectrum, is not limited to the colors green, red and yellow.

Furthermore, it is evident to a person skilled in the art that the prescribed preferred embodiments can be combined with one another in an arbitrary manner.

The features of the present invention can be combined with and among one another in an arbitrary manner.

1. A method for controlling an adaptive illumination apparatus, particularly for illuminating a goods presentation area, comprising the following steps:
provision of an adaptive illuminating apparatus, comprising:
at least one light emitting diode module that is set up to emit light having a specific spectrum;
a control unit for controlling the light emission of the light emitting diode module; and
an interface for wireless communication;
provision of a mobile terminal, comprising an interface for wireless communication and at least one digital camera unit;
provision of a digital depiction of the area to be illuminated by the adaptive illumination apparatus and/or of an object to be illuminated by the adaptive illumination apparatus (100) by means of the camera unit of the mobile terminal;
performance of an analysis of the digital depiction and ascertainment of at least one color that is dominant in the digital depiction;
actuation of the light emitting diode module by the control unit such that the latter takes the ascertained dominant color of the digital depiction as a basis for emitting light having a specific spectrum.

2. The method as claimed in claim 1, wherein the mobile terminal is a digital camera or a smartphone having a digital camera.

3. The method as claimed in claim 1, wherein the digital depiction is provided in raw data format (“raw data”), in JPEG format (“File Interchange Format”) or in TIFF format (“Tagged Image File Format”).

4. The method as claimed in claim 1, wherein the dominant color is ascertained by analyzing multiple digital depictions of the area to be illuminated or of the object to be illuminated.

5. The method as claimed in claim 1, wherein analysis of the digital depiction involves the brightness and/or the size and/or the surface condition of the area to be illuminated or of the object to be illuminated being analyzed.

6. The method as claimed in claim 1, wherein an actuation of the light emitting diode module comprises adjustment of the light emission angle and/or the light brightness and/or the light distribution.

7. The method as claimed in claim 1, wherein the digital depiction is transmitted from the mobile terminal to the adaptive illumination apparatus and the transmitted digital depiction is analyzed by a data processing program of an image analysis unit of the adaptive illumination apparatus

8. The method as claimed in claim 7, wherein the data processing program of the image analysis unit is in the form of an embedded data processing program.

9. The method as claimed in claim 1, wherein the digital depiction is analyzed by a data processing program that is stored on the mobile terminal, and wherein the mobile terminal transmits control data to the control unit of the adaptive illumination apparatus for the purpose of actuating the light emitting diode module.

10. The method as claimed in claim 1, wherein the mobile terminal transmits the digital depiction to a central computer unit, and wherein the digital depiction is analyzed by a data processing program that is stored on the central computer unit.

11. The method as claimed in claim 10, wherein the central computer unit transmits control data to the control unit of the adaptive illumination apparatus for the purpose of actuating the light emitting diode module.

12. The method as claimed in claim 10, wherein the central computer unit transmits control data to the mobile terminal, which transmits the control data to the control unit of the adaptive illumination apparatus for the purpose of actuating the light emitting diode module.

13. The method as claimed in claim 1, wherein the light emitting diode module is actuated by resorting to a database stored in the mobile terminal, the illumination unit or the central computer unit, which database stores predefined illumination patterns or control commands for the purpose of actuating the light emitting diode module, wherein the database is taken as a basis for associating the predefined illumination patterns or control commands with the analyzed and/or ascertained data, and the light emitting diode module is actuated on the basis of this association.

14. The method as claimed in claim 1, wherein the wireless communication between the mobile terminal and the adaptive illumination apparatus is effected by a wireless local communication network, particularly a Wi-Fi network or a WLAN (“Wireless Local Area Network”).

15. The method as claimed in claim 1, wherein the wireless communication between the mobile terminal and the adaptive illumination apparatus is effected by means of a Bluetooth transmission, a ZigBee transmission or an RF/DC transmission (“Radio Frequency Data Communication”).

16. An illumination system for performing a method as claimed in claim 1, comprising:
an adaptive illumination apparatus, having at least one light emitting diode module that is set up to emit light having a specific spectrum; a control unit for controlling the light emission of the light emitting diode module; and an interface for wireless communication;
a mobile terminal, comprising an interface for wireless communication and at least one digital camera unit for capturing a digital depiction of an area to be illuminated by the adaptive illumination apparatus and/or of an object to be illuminated by the adaptive illumination apparatus;
an analysis unit suitable for performing an analysis of the digital depiction, wherein at least one dominant color of the digital depiction is ascertained, and wherein the light emitting diode module is controllable on the basis of the ascertained dominant color of the digital depiction.

17. The illumination system as claimed in claim 16, wherein the mobile terminal is a digital camera or a smartphone having at least one digital camera.

18. The illumination system as claimed in claim 16, wherein the analysis unit is provided in the adaptive illumination apparatus, in the smartphone or in a central computer unit and particularly comprises an embedded data processing program.

19. The illumination system as claimed in claim 16, wherein the digital depiction is a depiction in raw data format (“raw data”), in JPEG format (“File Interchange Format”) or in TIFF format (“Tagged Image File Format”).

20. The illumination system as claimed in claim 16, wherein the interface for wireless communication of the mobile terminal and/or of the adaptive illumination apparatus is a Bluetooth interface, a ZigBee interface, an RF/DC interface, a Wi-Fi interface or a WLAN interface.
